(19) United States
(12) Patent Application Publication
(10) Pub. No.: US 2024/0383384 A1
(43) Pub. Date: Nov. 21, 2024

(54) HEAT RESISTANT AND WATER RESISTANT OR WATERPROOF FORM-FITTING BOAT SEAT COVER

(71) Applicant: Miranda Nash Alford, Ellaville, GA (US)

(72) Inventor: Miranda Nash Alford, Ellaville, GA (US)

(21) Appl. No.: 18/668,207

(22) Filed: May 19, 2024

Related U.S. Application Data
(60) Provisional application No. 63/503,466, filed on May 20, 2023.

(51) Int. Cl. B60N 2/60

(52) U.S. Cl. CPC B60N 2/6009; B60N 2/6036

(57) ABSTRACT

According to the present invention there is disclosed a single piece, form-fitting seat cover for covering boat seat fabrics of a small or medium boat seat. The form fitting seat cover being constructed of a fabric having heat-resistant, and water-resistant properties. The form fitting seat cover includes a top seat cover for slipping over a top of the boat seat for mounting onto the back of the boat seat and a bottom seat cover for mounting over the bottom of the boat seat. The top seat cover can be placed with an opening on the top end thereof on the back of the boat seat and then pulled downward to cover the back. The bottom seat cover can be placed with an opening on the rear end thereof and pulled backward to cover the bottom of the seat.

### CROSS-REFERENCE TO RELATED APPLICATIONS

This application claims the benefit of U.S. Provisional Patent Application No. 63/503,466 filed on May 20, 2023, which is incorporated in its entirety herein by reference.

### TECHNICAL FIELD OF THE INVENTION

The present invention is directed to a heat resistant and water resistant or waterproof form-fitting boat seat cover.

### BACKGROUND OF THE INVENTION

Boat seats are typically covered with vinyl or leather fabrics. These boat seat covers often rise above comfortable temperatures when exposed to heat. These heated covers frequently cause discomfort for the users of the seat and often results in damage to the seat. In addition to the heat, boat seats are often exposed to water causing further damage. A form-fitting boat seat cover that has heat-resistant and water-resistant or waterproofing properties will solve these issues.

There are many situations, however, in which selective or restrictive air temperature modification is desirable. For example, it is often desirable to provide an individualized climate control for an occupant seat so that substantially instantaneous heating or cooling can be achieved. For example, a boat exposed to the summer weather, where the boat is docked in an unshaded area for a long period of time, can cause the boat seat to be very hot and uncomfortable for the user for some time after embarking on the boat.

Furthermore, even with normal air-conditioning, on a hot day, the seat occupant's back and other pressure points may remain sweaty while seated. In the winter time, it is highly desirable to have the ability to quickly warm the seat of the occupant to facilitate the occupant's comfort, especially where the normal boat's heater is unlikely to quickly warm the interior of the boat.

Many types of seats utilize cushions or cushioning to provide increased support and/or comfort. Often, a cushion may be a distinct item placed in between a support surface and the object or person to be supported. Alternatively, some seats include one or more layers of built-in cushioning integral to the seat. Commonly, cushioning includes one or more layers of material that acts as an intervening barrier between the person and the support surface to reduce the amount of pressure that would otherwise be transferred between the person and the support surface. However, certain problems can arise with existing cushions. For example, existing cushions may undesirably act as an insulating layer which prevents the escape of heat from the person sitting on the support surface. Some cushions may reduce the pressure exerted by the person on the support surface to the degree that the seat fails to adequately support the person sitting in the chair. Accordingly, improvements of existing cushions are desirable.

### SUMMARY OF THE INVENTION

According to the present invention there is disclosed a single piece, form-fitting seat cover for covering boat seat fabrics of a small or medium boat seat. The form fitting seat cover being constructed of a fabric having heat-resistant, and water-resistant properties. The form fitting seat cover includes a top seat cover for slipping over a top of the boat seat for mounting onto the back of the boat seat and a bottom seat cover for mounting over the bottom of the boat seat. The top seat cover can be placed with an opening on the top end thereof on the back of the boat seat and then pulled downward to cover the back. The bottom seat cover can be placed with an opening on the rear end thereof and pulled backward to cover the bottom of the seat.

Further according to the present invention, there is disclosed two form-fitting boat seat covers each made of two layers of fabric. The fabric having heat-resistant and water-resistant or waterproof properties. The two form-fitting boat seat covers which slip onto a back of a relatively large seat and onto the bottom of the seat. The top seat cover can be placed with an opening on the top end of the back of the seat and then pulled downward to cover the back. The bottom seat cover can be installed onto the bottom of the seat by placing an open end onto the bottom of the seat and pulling the bottom seat cover to install the cover onto the bottom of the seat.

### BRIEF DESCRIPTION OF DRAWINGS

The structure, operation, and advantages of the present invention will become further apparent upon consideration of the following description taken in conjunction with the accompanying figures (Figs.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

FIG. 1 shows a form-fitting boat seat cover made of fabric with heat-resistant and water-resistant or waterproof properties which slips onto a seat, according to the present invention;

FIG. 1A shows two form-fitting boat seat covers made of fabric with heat-resistant and water-resistant or waterproof properties which slips onto the back of a seat and onto the bottom of the seat, according to the present invention;

FIG. 2 shows a large boat seat with a form-fitting boat seat cover secured to the back of the seat and the bottom of the seat using conventional closure systems, according to the present invention;

FIG. 3 shows a large, form-fitting boat seat cover made of a fabric with heat-resistant and water-resistant or waterproof properties for attaching to the back of the large boat seat, according to the present invention;

FIG. 4 shows a large, form-fitting boat seat cover made of a fabric with heat-resistant and water-resistant or waterproof properties for attaching to the bottom of the large boat seat, according to the present invention;

FIG. 5 shows a one piece, form-fitting boat seat cover made to fit a boat seat's form properties, according to the present invention;

FIG. 6 shows a one piece, form-fitting boat seat cover made to fit a boat seat's form properties, according to the present invention;

FIG. 7 shows a one piece, form-fitting boat seat cover with buckle made to fit a large boat seat's form properties, according to the present invention.

FIG. 8 shows a one piece, form-fitting boat seat cover made to fit a boat seat's form properties, according to the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader and should not in any way be interpreted as limiting.

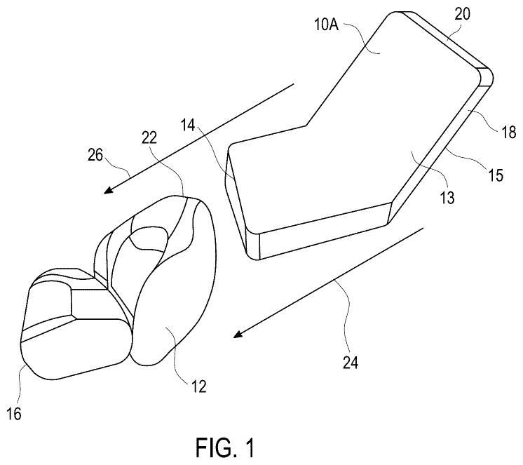

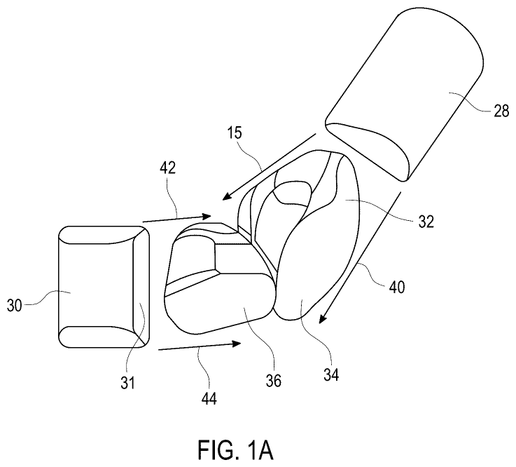

Referring to FIG. 1, there is illustrated a single piece, form-fitting seat cover 10 for a small or medium boat seat 12 made of a fabric with heat resistant and water resistant or waterproof properties to prevent potential burns or uncomfortable contact by one sitting on the boat seat. The seat cover 10 covers the original boat seat fabrics and keeps the original boat seat fabrics safe and intact. Boat seats are typically made with vinyl or leather fabrics. These fabrics become hot and weathered when exposed to external conditions. The intended use of the seat covers 10 will be to keep the boat seats 10 covered during and after use but may be removed and stored or washed as desired.

Form-fitting seat covers 10 for boat seats 12 made of a fabric with heat resistant and water resistant or waterproof properties are provided to prevent potential burns or uncomfortable contact with the original boat seat fabrics and keep original boat seat fabrics safe and intact. Synthetic materials or fabrics, such as for example, neoprene, polyester, canvas or of a similar nature with the same properties will be used. Due to their heat-resistant properties, these fabrics will prevent potential burns or uncomfortable contact by the user with the original boat seat fabrics like vinyl or leather that get hot when exposed to heat or the sun. This property of the synthetic materials will also prevent damage to the original boat seat fabrics due to weather or UV exposure. Due to the water-resistant or waterproof properties of the seat covers 10, the seats 12 will or should remain undamaged due to contact with water. The fabric used for the boat seat covers 10 can be treated with anti-mildewing/anti-molding solutions before sale, before use, or after use. The seat covers 10 may also be washed to prevent the formation of mildew and/or mold.

The goal of the present invention is to make a universal design for small, medium, and large bass boat seats.

The sizes will be made with similar designs with variations between the large size and the medium and small sizes. They will include other boat seats in the future, possibly with the same designs but different dimensions. The seat covers can be made slightly smaller than the seat to allow for stretching to ensure a tighter fit. A typical fabric used is 90% Polyester and 10% Spandex (marketed as neoprene), 1.5 mm, 33% horizontal stretch. If using another fabric, please make sure it has heat resistance, water resistance, and stretch.

Exemplary sizing for large and small boats as shown in FIG. 8.

For a large boat seat, the dimensions can be:
A Top Length of 22.5″
A Top Width of 24.5″
A Top Thickness of 6.5″
Bottom Length of 18″
Bottom Width of 21.5″
Bottom Thickness of 6″

For Medium Boat Seat Dimensions:
Top Length: 17.5″
Top Width: 17.5″
Top Thickness: 3.5″
Bottom Length: 17″
Bottom Width: 19.5″
Bottom Thickness: 4″

For Small Boat Seat Dimensions:
Top Length: 16″
Top Width: 13″
Top Thickness: 3″
Bottom Length: 16″
Bottom Width: 13″
Bottom Thickness: 3″

The Top cover 56 can slip over the top of the seat like a bag or glove. A drawstring closure on the back of the seat cover as shown in FIG. 3 can be provided with a small pocket with Velcro for the drawstring to be hidden and kept out of the way.

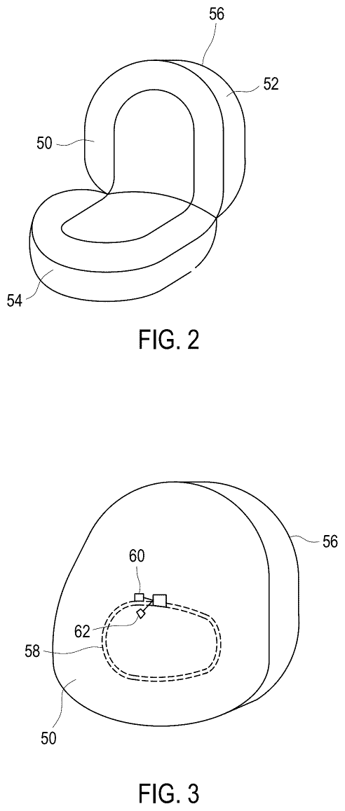

The bottom seat cover 54 slips on top of the seat like a cushion cover as shown in FIG. 2. A drawstring closure can be provided around the bottom of the seat cover 54. The bottoms of most large boat seats are attached to the boat in some form with a portion of the seat going past the attached area. The cover will fit over this lip and drawstring around the rim of the seat and end at the back of the seat. A small pocket can be placed on the bottom seat cover with Velcro for the drawstring to be hidden/kept out of the way.

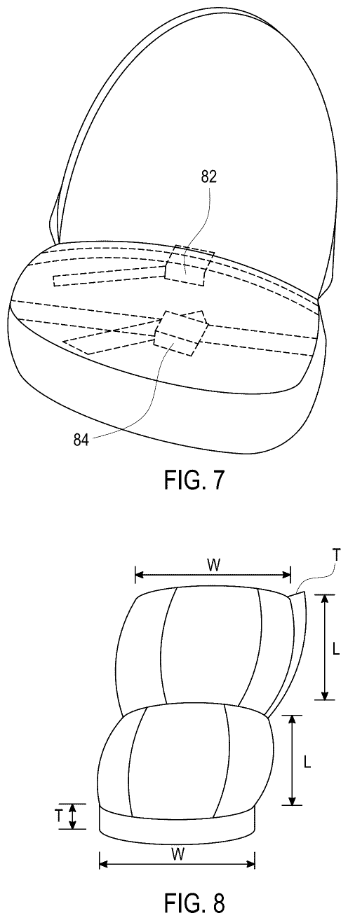

Alternatively, instead of a drawstring, an elastic with an adjustable Velcro cinch closure would work well around the bottom of the seat as shown in FIG. 7.

For a small or medium seat cover, a one piece with top and bottom together and no separation (except on the back to allow for the drawstring or elastic around the bottom rim) to fit the entire seat can be used. A small amount of extra fabric to allow for tucking into folding seams. When a drawstring is placed around the bottom rim of the seat, a small pocket and Velcro can be provided to keep the drawstrings hidden/kept out of the way. As with the large seat cover, a small or medium seat cover can incorporate an elastic with an adjustable Velcro cinch for attaching the seat cover around the bottom of the seat. To make the top of the seat cover more fitted, a drawstring to be added to the back bottom of the top or a flap can be added to tighten and Velcro to the bottom portion of the seat cover.

The small or medium seat covers 10 of FIG. 1 will be form-fitting and made as universal as possible or custom-made for specific seat shapes/types/brands. They may also be made to be mounted to seats of different sizes or they may be made as a universal fit for a variety of seat sizes while still be form-fitting like a glove. The seat covers may be made in different sizes such as large, medium, and small. They may be made as one seat cover to cover an entire small or medium seat or made in separate parts to cover the top section and bottom section of larger seats that are separated from each other.

The closure of the seat covers may be a conventional closure such as drawstrings, Velcro, elastic bands, zippers, buckles, etc. The closures may also include non-slip grip tape to secure areas that may be too loose. The seat covers may also include pockets to provide storage for items or storage for closure devices. The boat seat covers may also be customized by colors, patterns, logos, names, and similar fabrics with similar properties excluding fabrics made of materials not containing the heat-resistant and water-resistant or waterproof properties and excluding fits that do not form to the seat.

Referring to FIG. 1, there is illustrated a single piece, form-fitting seat cover 10 for a small or medium boat seat 12 made of a fabric with heat resistant and water resistant or waterproof properties to prevent potential burns or uncomfortable contact by one sitting on the boat seat. The seat cover 10 is made to fit the seat's form 12 in such a way that it can be sat on and utilized for everyday use. The cover 10 will slip over the entire seat 12 in a universal fit or a structured fit. It can be customized per boat seat and preference.

As shown in FIG. 1, the cover 10 can be formed of two layers of material 13 and 15 which are joined together with an opening 14 along the front bottom edge 14 so that the seat cover can be pulled onto the seat 12 from the opening along the front bottom edge 14 so that the front bottom edge 14 covers the front bottom edge 16 of the seat. Then, the back portion 18 of seat cover 10 can be pulled over the back of the seat 12 so that the upper section 20 of the top edge is pulled into engagement with the upper end 22 of the seat 12. This can be accomplished by pulling the seat cover 10 in the direction of the arrows 24 and 26.

The cover 10 will be secured using conventional closure systems such as drawstrings, Velcro, elastic bands, zippers, buckles, etc. The seat cover 10 may use non-slip grip tape to secure loose areas of fabric.

Referring to FIG. 1A, there is illustrated two form-fitting boat seat covers 28 and 30, each made of two layers of fabric with heat-resistant and water-resistant or waterproof properties which slip onto the back 32 of a relatively large seat 34 and onto the bottom 36 of the seat. The top seat cover 28 can be placed with the opening 29 on the top end of the back 32 of the seat 34 and then pulled downward in the direction of the arrows 38 and 40 to cover the back 32. The bottom seat cover 30 can be installed onto the bottom 36 of the seat by placing the open end 31 onto the bottom 36 of the seat and pulling the bottom seat cover 30 in the direction of the arrows 42 and 44 to install the cover 30 onto the bottom 36 of the seat.

Referring to FIG. 2, there is illustrated a large boat seat 50 with a top and bottom seat covers 52 and 54, each made of two layers of fabric with heat-resistant and water-resistant or waterproof properties which slip onto the back 52 and bottom 54 of a relatively large boat seat 34. The back of the top seat cover 56 can be secured in place with a draw string closure 58 as shown in FIG. 3. Once the top seat cover 56 is in place, the draw string closure 58 can be tightened in place by pulling on the two ends 60 and 62 of the draw string which extend outward from the closure 58.

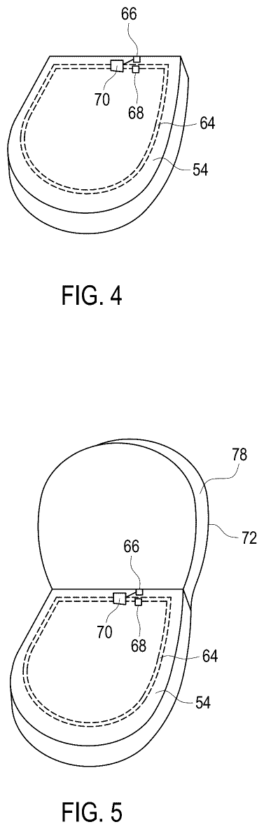

Referring to FIG. 4, the bottom seat cover 54 that covers the bottom seat can be secured in place with a draw string closure 64 as shown in FIG. 4. Once the bottom seat cover 54 is in place, the draw string closure 64 can be tightened in place by pulling on the two ends 66 and 68 of the draw string which extend outward from the closure 70.

Referring to FIG. 5, there is illustrated a seat cover 72 made of two layers of fabric with heat-resistant and water-resistant or waterproof properties which slip onto the back 74 and bottom 76 of a relatively large boat seat 78. The bottom seat cover 54 that covers the bottom seat can be secured in place with a draw string closure 64 as shown in FIG. 4. Once the bottom seat cover 54 is in place, the draw string closure 64 can be tightened in place by pulling on the two ends 66 and 68 of the draw string which extend outward from the closure 70.

Alternatively, instead of a drawstring, an elastic with an adjustable Velcro cinch closure would work well around the bottom of the seat as shown in FIG. 7. Will attach diagram separately.

For a small or medium seat cover, a one piece with top and bottom together and no separation (except on the back to allow for the drawstring or elastic around the bottom rim) to fit the entire seat can be used. A small amount of extra fabric to allow for tucking into folding seams. When a drawstring is placed around the bottom rim of the seat, a small pocket and Velcro can be provided to keep the drawstrings hidden/kept out of the way. As with the large seat cover, a small or medium seat cover can incorporate an elastic with an adjustable Velcro cinch for attaching the seat cover around the bottom of the seat. To make the top of the seat cover more fitted, a drawstring to be added to the back bottom of the top or a flap.

The seat covers will be form-fitting and made as universal as possible or custom-made for specific seat shapes/types/brands. May be made to be structured to seats or they may be made as a universal fit while still form-fitting like a glove. May be made in different sizes such as large, medium, and small. May be made as one seat cover to cover the entire seat or made in separate parts to cover the top section and bottom section of seats that are separated from each other. The closure of the cover may be a conventional closure such as drawstrings, Velcro, elastic bands, zippers, buckles, etc. May also include non-slip grip tape to secure areas that may be too loose. May also include pockets to provide storage for items or storage for closure devices. The boat seat covers may also be customized by colors, patterns, logos, names, and similar fabrics with similar properties excluding fabrics made of materials not containing the heat-resistant and water-resistant or waterproof properties and excluding fits that do not form to the seat.

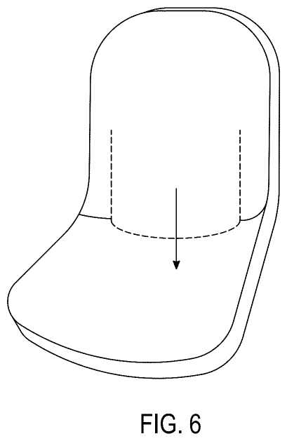

Referring to FIG. 6, there is illustrated a set having a Velcro flap 80 on the back which stretches down and secures the seat in pace.

In FIG. 7, there is illustrated buckles 82 and 84 which secure the bottom seat cover in place.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A single piece, form-fitting seat cover for covering boat seat fabrics of a small or medium boat seat;
the form fitting seat cover being constructed of a fabric having heat-resistant, and water resistant properties;
the form fitting seat cover including a top seat cover for slipping over a top of the boat seat for mounting onto the back of the boat seat and a bottom seat cover for mounting over the bottom of the boat seat;
the top seat cover can be placed with an opening on the top end thereof on the back of the boat seat and then pulled downward to cover the back; and
the bottom seat cover can be placed with an opening on the rear end thereof and pulled backward to cover the bottom of the seat.

2. The single piece, form-fitting seat cover of claim 1 wherein the seat cover is made of two layers of fabric with heat-resistant and water-resistant or waterproof properties which slip onto the back and bottom of a relatively small boat seat, respectively.

3. The single piece, form-fitting seat cover of claim 2 wherein the claim wherein the top and bottom seat covers can be secured in place with a first draw string closure.

4. The single piece, form-fitting seat cover of claim 3 wherein the seat cover covers boat seats typically made with vinyl or leather fabrics which become hot and weathered when exposed to external conditions.

5. The single piece, form-fitting seat cover of claim 4 wherein the seat cover will keep the boat seats covered during and after use and may be removed and stored or washed as desired.

6. The single piece, form-fitting seat cover of claim 5 wherein the seat cover is made of a fabric with heat resistant and water resistant or waterproof properties are provided to prevent potential burns or uncomfortable contact with the original boat seat fabrics and keep original boat seat fabrics safe and intact.

7. The single piece, form-fitting seat cover of claim 6 wherein the seat cover is made of a synthetic materials constructed of neoprene, polyester, or canvas.

8. The single piece, form-fitting seat cover of claim 7 wherein the seat cover will prevent potential burns or uncomfortable contact by the user with the original boat seat fabrics like vinyl or leather that get hot when exposed to heat or the sun.

9. The single piece, form-fitting seat cover of claim 8 wherein the seat cover will prevent damage to the original boat seat fabrics due to weather or UV exposure.

10. The single piece, form-fitting seat cover of claim 9 wherein the fabric used for the boat seat covers can be treated with anti-mildewing/anti-molding solutions before sale, before use, or after use.

11. The single piece, form-fitting seat cover of claim 10 wherein the fabric used for the boat seat covers the water-resistant or waterproof properties of the seat covers, the seats will or should remain undamaged due to contact with water.

12. The fabric used for the boat seat covers 11 can be treated with anti-mildewing/anti-molding solutions before sale, before use, or after use. The seat covers may also be washed to prevent the formation of mildew and/or mold.

13. The single piece, form-fitting seat cover of claim 12 wherein the top cover can slip over the top of the seat like a bag; and
a drawstring closure on the back of the seat cover is provided with a small pocket with Velcro for the drawstring to be hidden and kept out of the way.

14. The single piece, form-fitting seat cover of claim 13 wherein the bottom seat cover slips on top of the seat like a cushion cover and is provided with a drawstring closure around the rim of the seat and at the back of the seat.

15. Two form-fitting boat seat covers each made of two layers of fabric;
the fabric having heat-resistant and water-resistant or waterproof properties;
the two form-fitting boat seat covers which slip onto a back of a relatively large seat and onto the bottom of the seat.
the top seat cover can be placed with an opening on the top end of the back of the seat and then pulled downward to cover the back; and
the bottom seat cover can be installed onto the bottom of the seat by placing an open end onto the bottom of the seat and pulling the bottom seat cover to install the cover onto the bottom of the seat.

16. The two form-fitting boat seat covers of claim 15 being a top seat cover and a bottom seat cover each made of two layers of fabric with heat-resistant and water-resistant or waterproof properties which slip onto the back and bottom of a relatively large boat seat, respectively.

17. The two form-fitting boat seat covers of claim 16 wherein the back of the top seat cover can be secured in place with a first draw string closure.

18. The two form-fitting boat seat covers of claim 17 wherein the back of the bottom seat cover can be secured in place with a second draw string closure.

19. The two form-fitting boat seat covers of claim 18 wherein the seat cover is made of a fabric with heat resistant and water resistant or waterproof properties are provided to prevent potential burns or uncomfortable contact with the original boat seat fabrics and keep original boat seat fabrics safe and intact.

20. The two form-fitting boat seat covers of claim 19 wherein the fabric used for the boat seat covers the water-resistant or waterproof properties of the seat covers, the seats will or should remain undamaged due to contact with water.
